(19) United States
(12) Patent Application Publication
(10) Pub. No.: US 2008/0291361 A1
(43) Pub. Date: Nov. 27, 2008

(54) WIDE ANGLE MIRROR SYSTEM

(75) Inventor: Michael F. Weber, Shoreview, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/168,990

(22) Filed: Jul. 8, 2008

Related U.S. Application Data
(63) Continuation of application No. 11/691,769, filed on Mar. 27, 2007.
(60) Provisional application No. 60/744,112, filed on Mar. 31, 2006.

(51) Int. Cl. G02F 1/1335; F21V 7/04; F21V 1/12

(52) U.S. Cl. 349/62; 362/618; 362/360

(57) ABSTRACT

Composite mirror systems include a wideband thin film interference stack having a plurality of microlayers and an optically thick layer having a refractive index greater than air but less than the smallest refractive index of the stack. The mirror systems can provide high reflectivity for light propagating in the stack and in the optically thick layer at supercritical angles, while avoiding degradation in reflectivity if dirt or other disturbances such as absorbing materials are present at the mirror backside for example due to contact with a support structure.

### CROSS-REFERENCE TO RELATED APPLICATION

This application is a continuation application of U.S. Ser. No. 11/691,769, filed Mar. 27, 2007, which claims the benefit of the filing date of Provisional Application No. 60/744,112 filed Mar. 31, 2006, the disclosure of which is incorporated herein by reference.

### FIELD OF THE INVENTION

The present invention relates to mirror systems, and to mirror systems that utilize thin film interference stacks.

### BACKGROUND

Many optical products and devices that require a high reflectivity mirror use a thin film interference stack for that purpose. Such stacks can be made economically, and can be designed to provide high reflectivity over a desired wavelength band, such as the human visible wavelength spectrum or the output spectrum of a specified light source or the sensitivity spectrum of a specified detector. The stacks can also provide reflectivity over a range of angles of the incident light. Excellent reflectivity can usually be achieved—at a particular wavelength, or even over the entire wavelength range of interest—for normally incident light and for moderate angles of incidence. This performance is usually perfectly adequate for the intended end-use application.

However, if the application or system also requires high reflectivity at extreme angles of incidence, such a stack may not be able to deliver that performance. The reflectivity of an interference stack at a particular wavelength may degrade at such extreme angles because of two factors: (1) the reflectivity, for the p-polarized component of the light, of each dielectric/dielectric interface between adjacent microlayers in the stack decreases with increasing incidence angle—to a minimum of zero at Brewster's angle; and (2) from a geometric standpoint, the phase shift due to the optical path difference between wavelets of light produced by adjacent interfaces in the stack becomes so close to π/2 radians that, even with the cumulative effect of a large number of microlayers and an extended thickness gradient, constructive interference is insufficient to produce acceptable reflection. Factor (2) may be expressed differently by saying that the reflection band of the stack shifts toward shorter optical wavelengths as the angle of incidence increases, and that at extreme angles of incidence the reflection band shifts so far that it no longer covers the entire wavelength range of interest, or even so far that it no longer covers any portion of the wavelength range of interest. Regarding factor (1), U.S. Pat. No. 5,882,774 (Jonza et al.) and journal publication “Giant Birefringent Optics” by Weber et al., Science 287, 2365 (31 Mar. 2000), teach how this problem can be solved by utilizing at least some birefringent microlayers in the stack, and by selecting refractive indices of adjacent microlayers so as to reduce, eliminate, or even reverse the usual behavior (exhibited with isotropic microlayers) of decreasing reflectivity of p-polarized light with increasing angle of incidence. For example, these references teach how Brewster's angle can be eliminated with appropriate selection of refractive indices. Such an approach, however, does not resolve factor (2). In many cases, factor (2) cannot be resolved by simply adding more layers to extend the reflection band.

### BRIEF SUMMARY

Applicant has identified a need for mirror systems capable of reflecting light over wider ranges of incidence angles, in order to prevent factors (1) and (2) from unduly degrading reflectivity. Such mirror systems may be desirable, for example, in cases where a multilayer interference stack is combined with a front-surface diffusing structure, such as a front-surface coating that contains diffusing particles or other diffusing elements. The diffusing elements may scatter light in all directions in the multilayer stack, including extreme angles of incidence that would propagate to a rear major surface or backside of the multilayer stack due to factors (1) and/or (2). If the backside is flat, smooth, clean, and exposed to air, such light is reflected by total internal reflection (TIR) towards the front-surface of the multilayer stack, maintaining the high reflectivity of the mirror system. On the other hand, if the backside is scratched or in contact with an absorbing material (e.g. a support member, fastener, grease, ink, or dirt), such light is absorbed, detracting from system reflectivity. For example, application of a piece of double-sided adhesive tape to the backside of a multilayer interference stack, in a mirror system where the front of the multilayer interference stack is coated with a light diffusing layer, can cause a grey or otherwise darkened area, corresponding in size and shape to the contact area of the piece of tape to the stack, to become visible at the front of the mirror system. If the tape contacts or is replaced with a more strongly absorbent material such as an opaque plastic support or an absorbing ink, the area can become even darker from the standpoint of the front observer.

The darkened area visible at the front when a composite mirror based on a multilayer interference stack exhibits locally reduced backside reflectivity arises due to a combination of factor (2) and the localized loss of total internal reflection at the mirror backside. The diffusing elements cause some of the scattered light to enter the mirror at sufficiently high angles of incidence so that the light is not adequately reflected at wavelengths of interest (for example, due to a shift in the mirror reflection band at high angles of incidence). This light instead reaches the mirror backside and passes out of the mirror through the localized less reflective region(s). Meanwhile, light reaching adjacent regions of the mirror backside that have remained flat, smooth, clean, and exposed to air undergoes total internal reflection. The differing reflectivity at these adjacent regions causes a darkened area to become visible when the mirror is viewed from its frontside.

There exists, therefore, a need for mirror systems capable of reflecting light over wider ranges of incidence angles. There also exists a need for mirror systems that are capable of uniformly reflecting light incident from the front despite locally reduced reflectivity at a mirror backside region. These needs are not limited to visible wavelength mirrors, and can arise for other wavelength ranges of interest.

The present application therefore discloses, among other things, a composite mirror system that includes a plurality of microlayers forming a thin film interference stack, or forming multiple stacks. These microlayers have refractive indices and thicknesses selected to reflect light over a wavelength range of interest, and over an angular range of interest as measured in a reference medium corresponding to one of the microlayers. This latter range is referred to herein as a microlayer angular range of interest. The system also includes an optically thick layer that is coupled to the microlayers. The optically thick layer has an intermediate refractive index—greater than air, but less than the refractive indices of the microlayers. The mirror system also includes a component that injects light at “supercritical propagation angles” into the mirror system, e.g., into the optically thick layer and thence into the microlayers, or within the optically thick layer and thence into the microlayers. The concept of supercritical propagation angles is discussed further below, but generally refers to propagation angles in a layer of any non-air medium (such as the optically thick layer or the microlayers) that are more oblique than could be achieved by injecting light into the layer from air through a surface that is flat and parallel to such layer. The optically thick layer serves to limit the injected light within the wavelength range of interest to the microlayer angular range of interest, or causes the injected light within the wavelength range of interest and outside the microlayer angular range of interest to be totally internally reflected at an embedded interface of the optically thick layer. These disclosed mirror systems are typically able to provide high reflectivity not only for normally incident light but also light propagating at extreme angles of incidence, including supercritical angles of incidence, through a combination of the thin film interference stack, the optically thick layer of intermediate refractive index and the component for injecting light at supercritical propagation angles.

The application also discloses a mirror system that comprises a plurality of microlayers, an optically thick layer coupled to the microlayers, and structure(s) that inject light into the optically thick layers and the microlayers, including light that propagates in the optically thick layer at an angle of substantially 90°. The microlayers are generally perpendicular to a reference axis, and have refractive indices and thicknesses selected to substantially reflect light over a wavelength range of interest and over a microlayer angular range of interest. The optically thick layer has a refractive index greater than that of air but less than the refractive indices of the microlayers. The angular range of interest extends to an angle θₐₘₐₓ measured in a reference medium corresponding to that of one of the microlayers, and θₐₘₐₓ in the reference medium corresponds to a substantially 90 degree propagation angle in the optically thick layer.

The application also discloses a mirror system comprising a plurality of microlayers whose refractive indices and thicknesses reflect light over a wavelength range of interest and over a microlayer angular range of interest, an optically thick layer coupled to the microlayers and having a refractive index greater than air but less than the refractive indices of the microlayers, and one or more diffusing elements within or coupled to the optically thick layer, wherein the reflection band of the microlayers extends sufficiently far into the near infrared so that the mirror system appears to a human observer to reflect visible light uniformly despite locally reduced reflectivity at a mirror backside region.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification reference is made to the appended drawings, where like reference numerals designate like elements, and wherein:

FIG. 1 is a schematic cross-sectional representation of light obliquely incident from air on a thin film interference stack having alternating microlayers of material “a” and “b”;

FIGS. 2a-c are angular plots showing the range of possible propagation angles for light traveling in the various media of FIG. 1: FIG. 2a is for light in the air medium, FIG. 2b is for light in the “a” microlayers of the stack, and FIG. 2c is for light in the “b” microlayers of the stack;

FIG. 3 is a graph of reflectivity versus wavelength, with several idealized curves drawn representing the reflection band of an isotropic thin film stack at normal incidence and at several oblique angles of incidence;

FIG. 4 depicts idealized graphs of average reflectivity versus propagation angle in the “a” microlayers of the stack (θₐ) for different mirror system configurations, where reflectivity is for light at a wavelength (or averaged over a wavelength range) of interest, and averaged over all polarization states;

FIG. 5 is a schematic side view of a mirror system having a thin film stack coupled to a structure capable of injecting light at supercritical angles in the stack;

FIGS. 6-8 depict mirror systems having alternative structures capable of injecting light at supercritical angles in the stack;

FIG. 9 is a schematic cross-sectional view of a wide angle mirror system that includes a thin film stack and an optically thick layer of intermediate refractive index that limits the propagation angle of light within the stack, and also causes light propagating at extreme angles of incidence beyond the capability of the stack to be totally internally reflected at an embedded interface of the optically thick layer;

FIGS. 9a-c are angular plots showing the range of propagation angles for light traveling in the various media of FIG. 9: FIG. 9a is for light in the injection layer (“c”), FIG. 9b is for light in the optically thick intermediate index layer (“i”), and FIG. 9c is for light in the lowest refractive index “a” microlayers of the stack;

FIG. 10 is a schematic cross-sectional view of another wide angle mirror system, and FIGS. 10a-c are angular plots showing the range of propagation angles for light traveling in the various media of FIG. 10;

FIG. 11 is a schematic cross-sectional view of still another wide angle mirror system, and FIGS. 11a-b are angular plots showing the range of propagation angles for light traveling in the various media of FIG. 11; and

FIGS. 12-16 are plots showing spectral transmission or reflection for various mirror systems discussed in the Examples.

### DETAILED DESCRIPTION OF THE ILLUSTRATIVE EMBODIMENTS

For purposes of this detailed description, the term “air” can refer to terrestrial atmosphere at standard temperature and pressure, or at other temperatures or pressures, and can even refer to vacuum. The fine distinctions between the refractive indices of such media are ignored herein, and the refractive index is assumed to be essentially 1.0 Also for purposes of this detailed description, the following terminology is used:

nₘᵢₙ—smallest refractive index of any of the microlayers in the stack along any axis, at the wavelength or wavelength range of interest.

a,b—optical materials used in the thin film stack, or the microlayers composed of such materials, where a has the refractive index nₘᵢₙ along at least one axis, and b has a refractive index along at least one axis that is greater than nₘᵢₙ; the b material usually also has the largest refractive index (along any axis) in the stack. This does not mean that the film stack is limited to only two different types of microlayers; the stack can also include optical materials other than “a” and “b”.

i—another optical material, or layer or other body composed of such material, having an intermediate refractive index nᵢ between that of air (n=1) and the smallest refractive index of the stack (n=nₘᵢₙ).

c—another optical material, or layer or other body composed of such material, whose refractive index along any axis is greater than nᵢ, and usually substantially greater than nᵢ and nₘᵢₙ. In some cases, the “c” material can be the “a” material or the “b” material.

nₓ—refractive index of a given material or layer x (x=a, b, c, or i), at a wavelength or wavelength range of interest. If the material is birefringent, nₓ can be the refractive index along a particular axis (e.g., along the x-, y-, or z-axis) or can be the effective refractive index for a particular polarization state (e.g., for s- or p-polarized light, or left- or right-hand circularly polarized light) propagating in a given direction.

wavelength range of interest—usually visible or near-visible light (e.g., 400-700 nm wavelength), near infrared light (e.g., 700-1000 nm, 700-1400 nm or 700-5000 nm with the selection of one of these ranges sometimes being dependent on the detector or transmission medium employed), or both visible and near infrared light. Other ranges may also be used as the wavelength range or interest. For example, if the mirror system is to be used in a system with a narrow band emitter, such as an LED or laser, the wavelength range of interest may be relatively narrow (e.g., 100 nm, 50 nm, 10 nm, or less). If the mirror system is to be used in lighting systems such as backlights for liquid crystal display (LCD) devices or other displays, the wavelength range of interest may be broader (e.g., 400-800 nm, 400-900 nm, 400-1000 nm, 400-1200 nm, 400-1400 nm, 400-1600 nm or 400-1700 nm); these ranges extend beyond the visible for reasons explained in more detail below.

θₓ—angle of a light ray propagating in medium x, measured in medium x relative to an axis that is perpendicular to medium x or to a surface of medium x.

θ_{xc}—the critical angle for medium x, i.e., the angle of incidence measured in medium x for which light refracts into an adjacent air medium at a grazing angle (90°). Note that the second subscript “c” stands for “critical”, and should not be confused with optical material “c”, which may appear as the first subscript.

θₓₗᵢₘ—a limiting angle for medium x analogous to the critical angle, but where the adjacent medium is not air. Thus, θₓₗᵢₘ is the angle of incidence measured in medium x for which light refracts into an adjacent non-air medium at a grazing angle (90°).

θₐₘₐₓ—maximum light propagation angle measured in medium “a” for which the thin film stack provides adequate reflectivity over the wavelength range of interest. This angle is a function of many factors, such as the required or target reflectivity in the intended application, and details of the stack design such as the total number of microlayers, thickness gradient of the microlayer stack, refractive index difference between microlayers, and so forth.

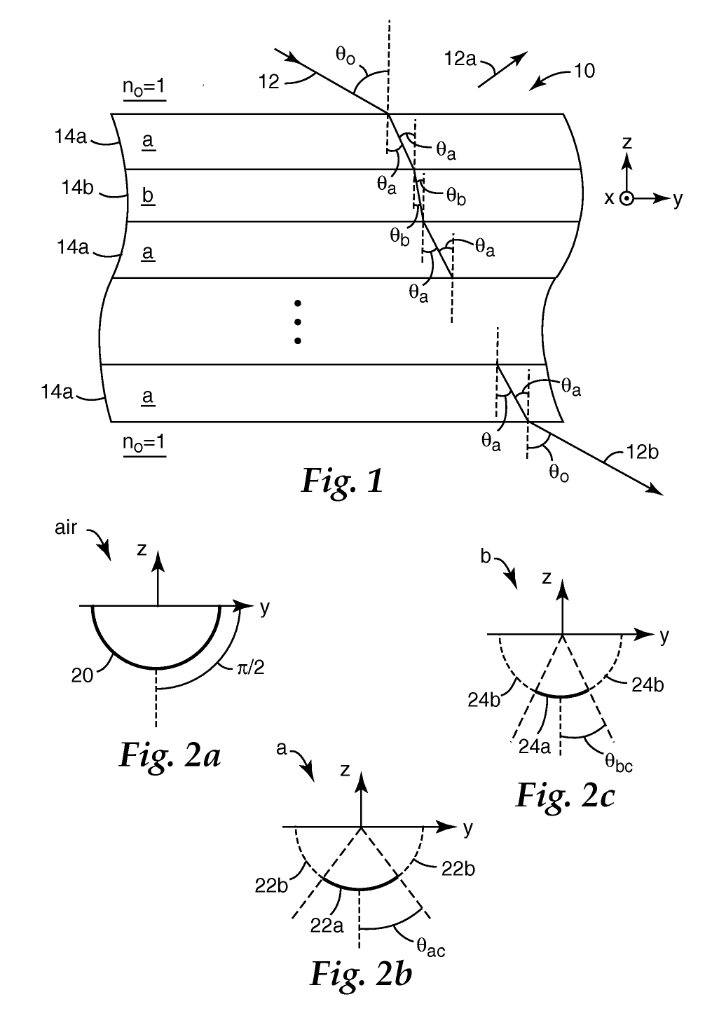

Turning now to FIG. 1, we see there in schematic cross-section a thin film interference stack 10 immersed in an air medium of refractive index n₀=1. A Cartesian x-y-z coordinate system is also shown for reference purposes. Light 12 of a particular wavelength is incident on the stack at an angle θ₀, interacting with the stack to produce a reflected beam 12a and a transmitted beam 12b.

The stack includes typically tens, hundreds, or thousands of microlayers 14a, 14b, composed respectively of optical materials a, b arranged in an interference stack, for example a quarter-wave stack. Optical materials a, b can be any suitable materials known to have utility in interference stacks, whether inorganic (such as TiO₂, SiO₂, CaF, or other conventional materials) or organic, e.g., polymeric (polyethylene naphthalate (PEN), polymethyl methacrylate (PMMA), polyethylene terephthalate (PET), acrylic, and other conventional materials). The stack may have an all-inorganic, all-organic, or mixed inorganic/organic construction. Initially, for ease of explanation, we discuss the case where the microlayers are isotropic, but the results can be readily extended to birefringent microlayers. Birefringent microlayers may be utilized in symmetric reflective systems, which reflect normally incident light of any polarization substantially equally, or in asymmetric reflective systems, which have high reflectivity for normally incident light of one polarization and lower reflectivity for normally incident light of an orthogonal polarization.

The microlayers have an optical thickness (physical thickness multiplied by refractive index) that is a fraction of a wavelength of light. The microlayers are arranged in repeating patterns, referred to as optical repeat units (ORUs), for example where the optical thickness of the ORU is half the wavelength of light in the wavelength range of interest. Such thin layers make possible the constructive or destructive interference of light responsible for the wavelength-dependent reflection and transmission properties of the stack. The ORU for stack 10 is the pair of layers ab, but other known arrangements are also possible, such as the arrangements discussed in U.S. Pat. No. 5,103,337 (Schrenk et al.), U.S. Pat. No. 3,247,392 (Thelen), U.S. Pat. No. 5,360,659 (Arends et al.), and U.S. Pat. No. 7,019,905 (Weber). A thickness gradient, wherein the optical thickness of the ORUs changes along a thickness dimension of the stack, can be incorporated into the stack to widen the reflection band, if desired. The stack 10 need not be flat or planar over its entire extent, but can be shaped, molded, or embossed into non-planar shapes as desired. At least locally, however, as with the portion of the stack shown in FIG. 1, the microlayers can be said to lie or extend substantially parallel to a local x-y coordinate plane. Hence, the local z-axis is perpendicular to the microlayers, and perpendicular to each interface between adjacent microlayers.

For simplicity of illustration, only the refracted portion of incident light 12 is depicted in FIG. 1, but the reader will understand that wavelets of reflected light are also produced at the interfaces of the microlayers, and the coherent summation of those wavelets yields the reflected beam 12a. As the incident light 12 encounters the stack 10, it refracts from an angle of θ₀ in air to an angle of θₐ in microlayer 14a. From there, it bends even further towards the surface normal (which is parallel to the z-axis) as it enters microlayer 14b, achieving a propagation angle θ_{b}. After more refractions in the alternating a,b layers, the light emerges as transmitted beam 12b, which is also understood to be the coherent summation of all wavelets transmitted through the stack 10.

We now consider the effect of changing the direction of the incident light. If no limits are placed on the direction of the incident light, e.g., if we illuminate the stack from all directions in air, the incident angle θ₀ ranges from 0 to 90°, or from 0 to π/2 radians. The light propagation angle in the microlayers also changes, but because of the different refractive indices they do not sweep out a π/2 half-angle. Rather, they sweep out a half-angle of θ_{ac} (for layers 14a) and θ_{bc} (for layers 14b). This is shown graphically in the angular plots of FIGS. 2a-c. In FIG. 2a, the arc 20, having a half-angle of π/2, represents all propagation directions from the air medium. Such propagation directions actually form a hemisphere in three dimensions, and FIG. 2a shows a section of the hemisphere in the y-z plane. Through refraction, this range of incidence angles in air translates into a narrower range of incidence angles in optical material a, shown in FIG. 2b. In that figure, solid arc 22a, whose half-angle is the critical angle θ_{ac}, represents all propagation directions of the injected light in layers 14a.

Critical angle θ_{ac} can be calculated as sin⁻¹(1/nₐ). Broken arcs 22b represent propagation angles θₐ greater than θ_{ac}, referred to herein as supercritical propagation angles. Thus, supercritical propagation directions or angles generally refer to propagation angles in a layer of any non-air medium (such as the optically thick layer or the microlayers) that are more oblique than could be achieved by injecting light into the layer from air through a surface that is flat and parallel to such layer. Since this is precisely the case in FIG. 1—light is injected into the stack 10 from all angles in air through a surface that is flat and parallel to the microlayer 14a in question—no light propagates within microlayers 14a at these supercritical angles, and the arc 22b is therefore shown as broken rather than solid.

The angular plot of FIG. 2c is similar to that of FIG. 2b, but for light propagating in higher refractive index microlayers 14b. Solid arc 24a, whose half-angle is the critical angle θ_{bc} (equal to sin⁻¹(1/n_{b})), represents all propagation directions of the injected light in layers 14b. Broken arcs 24b represent propagation angles greater than θ_{bc}, i.e., supercritical angles in microlayers 14b. Using the air-injection arrangement of FIG. 1, no light propagates at these supercritical angles.

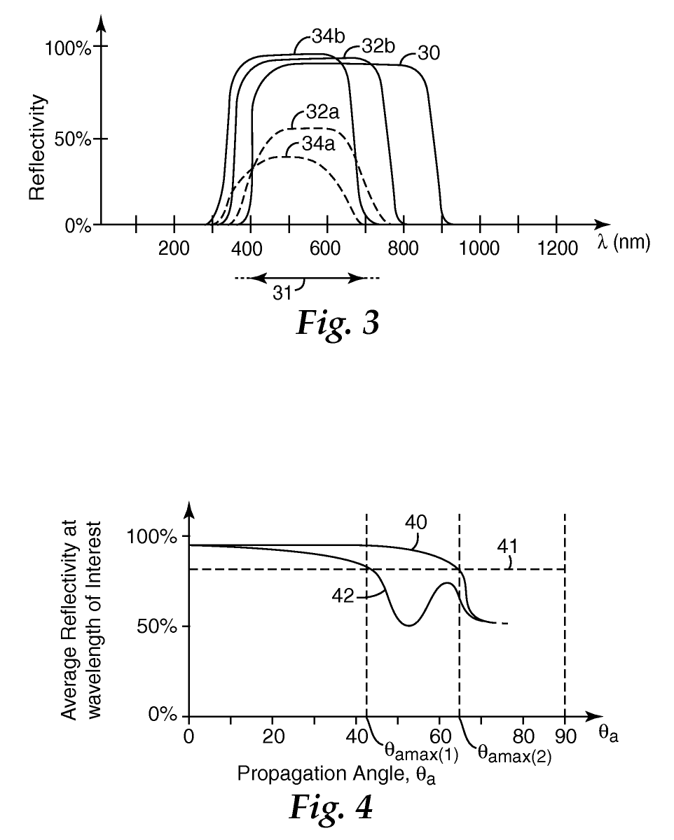

FIG. 3 shows a graph of idealized reflectivity characteristics of a thin film stack such as stack 10 of FIG. 1. Curve 30 shows the reflectivity of the stack at normal incidence, i.e., θ₀=θₐ=θ_{b}=0. Those of ordinary skill in the art of thin film design can readily select alternating materials of suitable refractive index, microlayer thickness profile across the stack, and total number of microlayers to provide a stack having the characteristics shown: a reflection band extending throughout the visible region 31 and extending into the near infrared, having sharp left- and right-band edges, and having a high average reflectivity throughout at least the visible region (and for some applications also throughout the near infrared) of at least 70%, 80%, or 90% or more. Reference is made, for example, to Vikuiti™ Enhanced Specular Reflector (ESR) film sold by 3M Company, which utilizes a birefringent multilayer stack. Reference is also made to modified films that may be made by laminating a birefringent multilayer stack such as Vikuiti™ ESR film to a thin film stack whose reflection band extends further into the infrared, as discussed below in the Examples.

As the incidence angle is increased from 0°, two effects begin to occur that are related to the factors (1) and (2) discussed above. First, the reflectivity of the interfaces between microlayers is different for p-polarized light (polarized in the plane of incidence) compared to s-polarized light (polarized perpendicular to the plane of incidence), resulting in a split of the normal incidence reflection band into a first reflection band 32a for p-polarized light and a distinct second reflection band 32b for s-polarized light. In cases where only isotropic materials are used in the thin film stack, the peak reflectivity of the reflection band for p-polarized light decreases monotonically with increasing incidence angle until the Brewster angle is reached, whereupon the reflectivity of p-polarized light becomes zero. Second, both reflection bands 32a, 32b shift to shorter wavelengths due to the effect of phase shift discussed above in connection with factor (2). As the incidence angle increases further, the reflection bands continue to shift to shorter wavelengths, shown by first reflection band 34a for p-polarized light and second reflection band 34b for s-polarized light. Note that although the peak reflectivity for p-polarized light decreases as the incidence angle approaches the Brewster angle, the peak reflectivity for s-polarized light increases with increasing incidence angle.

Regarding factor (1), U.S. Pat. No. 5,882,774 (Jonza et al.) shows how the decline in reflectivity for p-polarized light with increasing incidence angle can be reduced, eliminated, or reversed. In short, birefringent materials are used in the film stack such that the refractive index mismatch along the z-axis between adjacent microlayers is controlled to be small (e.g., one-half or one-fourth or less) or zero or opposite in sign relative to the refractive index mismatch along the in-plane (x- or y-) axes. A zero or near zero magnitude z-index mismatch yields interfaces between microlayers whose reflectivity for p-polarized light is constant or near constant as a function of incidence angle. A z-index mismatch of opposite polarity compared to the in-plane index difference yields interfaces whose reflectivity for p-polarized light increases with increasing angles of incidence, as is the case for s-polarized light. Using teachings such as this, thin film stacks can readily be made that maintain high peak reflectivity for both s- and p-polarized light.

As mentioned above, however, maintaining high reflectivity interfaces for all polarizations does little or nothing to stop the shift of the reflection band to shorter and shorter wavelengths as the incidence angle increases, i.e., the phenomenon of factor (2). Indeed, the use of birefringent materials to extend or eliminate the Brewster angle may accelerate the wavelength shift with angle. Eventually, at some angle, the reflection band no longer covers the wavelength range of interest, and reflectivity in that spectral range drops below an acceptable level or target. This angle is referred to as θₐₘₐₓ. It is evaluated or measured in stack medium a.

From a design standpoint, θₐₘₐₓ can be increased to higher angles by adding more and more microlayers to the thin film stack design, and extending the layer thickness profile to include layers of greater optical thickness. But for reasonably high target reflectivity values, θₐₘₐₓ cannot reach 90° with any finite number of microlayers.

In some cases it may be sufficient to tailor the z-index mismatch between adjacent microlayers in the multilayer stack to simply extend the Brewster angle at the corresponding interfaces to be closer to 90 degrees (relative to a multilayer stack having only isotropic microlayers), rather than tailoring the z-index mismatch to eliminate the Brewster angle completely. For example, it may be sufficient for the Brewster angle, measured in medium “a”, to be greater than θₐₘₐₓ.

It should also be noted that-even for thin film stacks that utilize the z-index matching technique to achieve high interfacial p-polarization reflectivity- the s- and p-reflection bands at high incidence angles have different shapes, and have different bandwidths because their left- and right-band edges do not shift the same amount with changing incidence angle. Differences between the s- and p- reflection bands are most pronounced for supercritical angles θₐ approaching 90°. Typically, the p-polarized reflection band is narrower than the s-reflection band, and as θₐ increases the right band edge of the p-reflection band will move across a given wavelength of interest before the s-reflection band does. In other words, even if the stack is designed for high interfacial reflectivity for p-polarized light, as θₐ increases, a first major drop in reflectivity at a wavelength or wavelength range of interest will typically be due to the shift of the reflection band for p-polarized light to shorter wavelengths, but the reflectivity of s-polarized light at such an angle may remain high at the wavelength or wavelength range of interest.

In one modeled example, a birefringent quarter wave thin film stack having 550 microlayers was evaluated. The “a” layers had refractive indices of 1.49, 1.49, and 1.49 along the x-, y-, and z-axes respectively—representative of polymethyl methacrylate (PMMA) optical material at 633 nm. These indices yield a critical angle θ_{ac} of about 42°. The “b” layers had refractive indices of 1.75, 1.75, and 1.49 along the x-, y-, and z-axes respectively—representative of oriented polyethylene naphthalate (PEN) optical material at 633 nm. The model also took into account the actual dispersion of PMMA and PEN materials. With a suitable layer thickness gradient, the normal incidence reflection band of the stack could be made to extend from about 400 nm to about 1600 nm. The reflection band maintained about 99% average reflectivity over the visible region for propagation angles θₐ from 0 to about 65°. Beyond about 65°, the shift of the p-reflection band was responsible for a sharp drop in the average reflectivity. θₐₘₐₓ was thus about 65° for a target average reflectivity of 99%.

FIG. 4 plots idealized representations of average reflectivity versus propagation angle θₐ in medium “a”, and contains qualitative features that are believed to be accurate for particular types of stacks. Reflectivity is assumed to be averaged over all polarization states and over the wavelength range of interest. Curve 40 depicts the reflectivity of a birefringent stack having a substantial z-index match between adjacent microlayers, similar to the 550 layer stack described above. Curve 42 depicts the reflectivity of a completely isotropic stack having a similarly large number of microlayers and a similar normal incidence reflection band. Both curves 40, 42 have high reflectivity at normal incidence and for moderate values of θₐ. Also, both curves drop precipitously near a supercritical angle θₐₘₐₓ₍₂₎. It is near this angle θₐₘₐₓ₍₂₎ that the band shift to shorter wavelengths causes the reflection band to move outside of the wavelength range of interest. Curve 40, due to its good oblique angle p-polarization reflectivity, maintains a relatively high reflectivity over the range 0≦θₐ≦θₐₘₐₓ₍₂₎. Curve 42, in contrast, degrades in reflectivity over that range, and falls below a target average reflectivity 41 at an angle θₐₘₐₓ₍₁₎ due to the Brewster angle effects. Curve 40 crosses the target reflectivity 41 at angle θₐₘₐₓ₍₂₎. Note that if the target average reflectivity 41 were selected to be higher with no change in the thin film stack designs, θₐₘₐₓ₍₁₎ and θₐₘₐₓ₍₂₎ would shift to smaller angles, and if the target average reflectivity 41 were selected to be lower, θₐₘₐₓ₍₁₎ and θₐₘᵢₙ₍₂₎ would shift to higher angles. The selection of the target average reflectivity is strongly dependent on the intended application of the mirror, but typical values include 90%, 95%, 96%, 97%, 98%, and 99%.

We turn our attention now to FIGS. 5-8 for a discussion of various structures that can be used to inject supercritical propagating light in the stack, and problems that can arise if the designer uses only a conventional thin film stack to accomplish the reflecting function. The structures-such as prisms, light guides, diffusing particles (e.g., scatterers), or roughened or microstructured surfaces-are normally not provided for the sole purpose of injecting supercritical light into the stack. Rather, the supercritical light injection is a result of the functions the structure performs in the intended end-use application.

In FIG. 5, a prism 50 made of an optical material “c” having refractive index n_{c} is optically coupled to, preferably in intimate optical contact with, a thin film stack 52, which in turn includes microlayers composed of optical materials “a” and “b”. Optical material c may be identical to materials a or b, but n_{c} is no less than nₘᵢₙ, the minimum refractive index of the microlayers in the stack. Prism 50 may be physically large or small, may extend linearly along an axis perpendicular to the drawing, or may be pyramidal in shape, and may be one of an array of similar or dissimilar prisms. The prism surfaces need not be flat or regular, and any suitable prism angle can be used. For example, any of the prism geometries embodied in the Vikuiti™ Brightness Enhancement Film (BEF) line of products, or in the 3M™ Scotchlite™ Reflective material line of products, both sold by 3M Company, can be used.

Film stack 52 can be similar to film stack 10 described previously. Stack 52 preferably includes tens, hundreds, or thousands of microlayers, which may be arranged in a single stack or packet, or in multiple stacks or packets separated by optically thick protective boundary layers (PBLs). The number of microlayers, and their thicknesses and refractive indices, are selected to provide an average reflectivity greater than a target average reflectivity, over the wavelength range of interest and over a range of propagation angles θₐ that include supercritical angles and that extends to a maximum angle θₐₘₐₓ, where 0≦θₐₓ≦θₐₘₐₓ≦90°. Stack 52 may also include optically thick skin layers at its outer major surfaces. In this regard, a layer is said to be optically thick if its optical thickness is on the order of the average wavelength of the wavelength range of interest, or greater. Preferably, the optical thickness is at least 10, 50, or 100 times such average wavelength. Note also that any skin layers or PBLs may be considered to be part of the thin film stack provided they do not have any refractive index less than nₘᵢₙ, the minimum refractive index of the microlayers in the stack. Usually, any skin layers or PBLs are composed of one of the materials a,b used for the microlayers. The film stack 52 may be entirely polymeric, and may be made by a coextrusion process and preferably also a stretching process to induce an appropriate amount of birefringence in the microlayers to enhance interfacial p-polarization reflectivity as discussed above. Alternatively, film stack 52 may include or be limited to inorganic materials, and may be made by vacuum evaporation techniques. Reference is made to U.S. Pat. No. 6,590,707 (Weber) for a teaching of birefringent thin film stacks that can utilize inorganic materials and form birefringence. If the film stack 52 is manufactured separately from prism 50, it can be laminated thereto with an optically thin or thick layer of optical adhesive or other suitable material.

Light from a light source 54 emitting light in the wavelength range of interest strikes prism 50 at prism surface 56, which is substantially tilted relative to the film stack 52. The light refracts into the prism 50 and then impinges on the stack 52. As a result of the tilt of the prism surface 56 and the refractive index n_{c} of the prism, light is able to propagate in the stack 52 at angles greater than the critical angle θ_{ac}, i.e., at supercritical angles. Stack 52, as explained above, satisfactorily reflects the light of interest propagating at angles between θₐ=0 and θₐ=θₐₘₐₓ, including some supercritical angles θ_{ac}≦θₐ≦θₐₘₐₓ. However, stack 52 does not satisfactorily reflect light propagating at other supercritical angles for which θ_{ac}>θₐₘₐₓ, referred to herein as extreme propagation angles or extreme incidence angles. Such light propagates through the entire stack 52 until it reaches an outer major surface 52a of the stack, shown in FIG. 5. If surface 52a is flat, smooth, clean, and exposed to air, this light will experience total internal reflection (TIR) at surface 52a, and will propagate back through the stack 52 and enter the prism 50 as if it had been reflected like the other light propagating at less extreme incidence angles (0≦θₐ≦θₐₘₐₓ). However, surface 52a (or portions thereof) may be greasy, dirty, scratched, or otherwise in contact with another material, whether a mounting bracket, support member, substrate, or coating, for example. Such disturbances to the surface 52a are depicted schematically in FIG. 5 by disturbance 58, and represent areas of locally reduced reflectivity in surface 52a. Thus, wherever a disturbance 58 is located, light at the extreme propagation angles will exit the stack 52 through surface 52a, and detract from the reflectivity at that location. The light that transmits or leaks through the stack is labeled 59 in the figures.

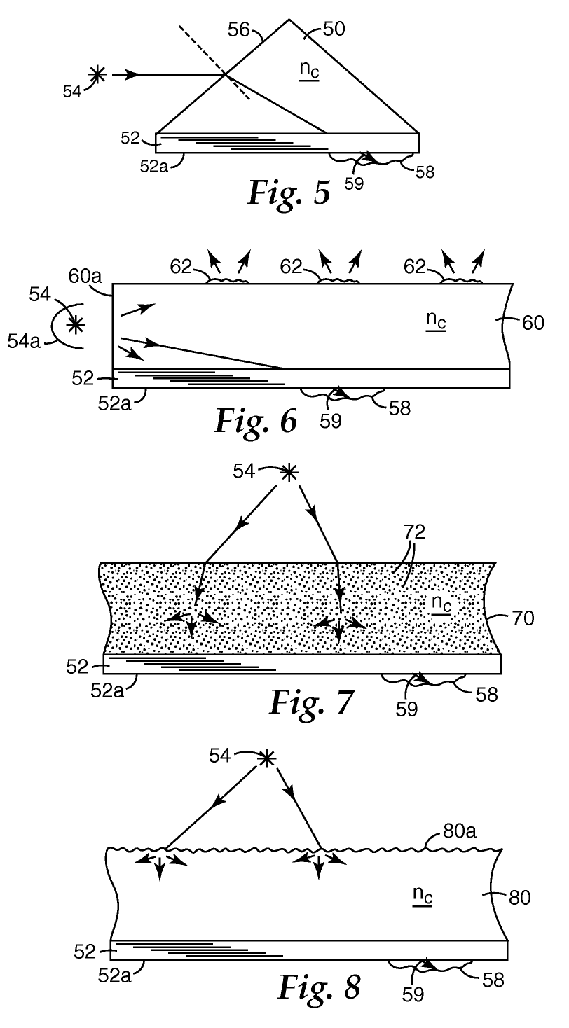

In FIG. 6, prism 50 is replaced by a light guide 60, and light source 54 includes a reflector 54a to help inject light more efficiently into the light guide 60 through a side surface 60a thereof. The light guide is made of an optical material “c”, described above, and is optically coupled to thin film stack 52, also described above. The light guide may be of any desired size or shape, and may be of uniform thickness or tapered. The light guide may for example be suitable for use in a backlight for a liquid crystal display (LCD) in a mobile phone, laptop computer, television, or other application. Extraction features 62 are provided on a front surface or elsewhere on or in the light guide as is known to direct light out the light guide towards a liquid crystal panel or other component to be illuminated.

Because light is injected into the light guide 60 through side surface 60a, light can propagate at high incidence angles in the light guide and also in the stack 52. As explained above, the stack satisfactorily reflects any light in the wavelength range of interest propagating at angles from 0≦θₐ≦θₐₘₐₓ, but does not satisfactorily reflect light at the extreme propagation angles. Localized disturbance 58 on outer major surface 52a of the stack causes such light 59 to exit the stack 52 through surface 52a, again detracting from the reflectivity at that location.

In FIG. 7, light guide 60 is replaced by an optical component 70 containing diffusing particles 72 dispersed in a matrix material of refractive index n_{c}. The particles 72 can be of any desired type or configuration, whether in composition, size, distribution, or otherwise, so long as they substantially scatter light. Component 70 can be a relatively thin or thick layer, or a more complicated structure. For example, component 70 may be a skin layer. Component 70 may also be an adhesive layer, such as a pressure sensitive adhesive or other adhesive. Light from light source 54 may enter component 70 from an air medium, but due to the particles 72 light is scattered and propagates in essentially all directions in component 70. This light then impinges on the stack 52 from all angles. The stack satisfactorily reflects any light in the wavelength range of interest propagating at angles from 0≦θₐ≦θₐₘₐₓ, but does not satisfactorily reflect light at the extreme propagation angles. Localized disturbance 58 on outer major surface 52a of the stack causes such light to exit the stack 52 through surface 52a, detracting from the reflectivity at that location.

In FIG. 8, optical component 70 is replaced by an optical component 80 having a textured, roughened, microstructured, or otherwise non-smooth surface 80a. The surface 80a may be simply roughened as with a matte finish, or may be microreplicated with a precision geometric pattern, or may contain minute facets forming a diffractive element such as a hologram. Optical component 80 is composed of optical material “c” of refractive index n_{c}. The non-smooth surface 80a refracts, diffracts, or otherwise scatters light from light source 54, which may be in an air medium, such that light propagates at high incidence angles in optical component 80. Stack 52 is optically coupled to the component 80, and light from the component 80 impinges on the stack from all angles, or at least over a range of supercritical angles. The stack satisfactorily reflects any light in the wavelength range of interest propagating at angles from 0≦θₐ≦θₐₘₐₓ, but does not satisfactorily reflect light at the extreme propagation angles. Localized disturbance 58 on outer major surface 52a of the stack causes such light 59 to exit the stack 52 through surface 52a, detracting from the reflectivity at that location.

The reader will understand that the structures shown in FIGS. 5-8 for injecting supercritical propagating light in the stack are merely exemplary, and are not to be considered as limiting. Further, the structures can be combined in any manner, such as incorporating diffusing particles in a prism or incorporating a non-smooth surface on a light guide.

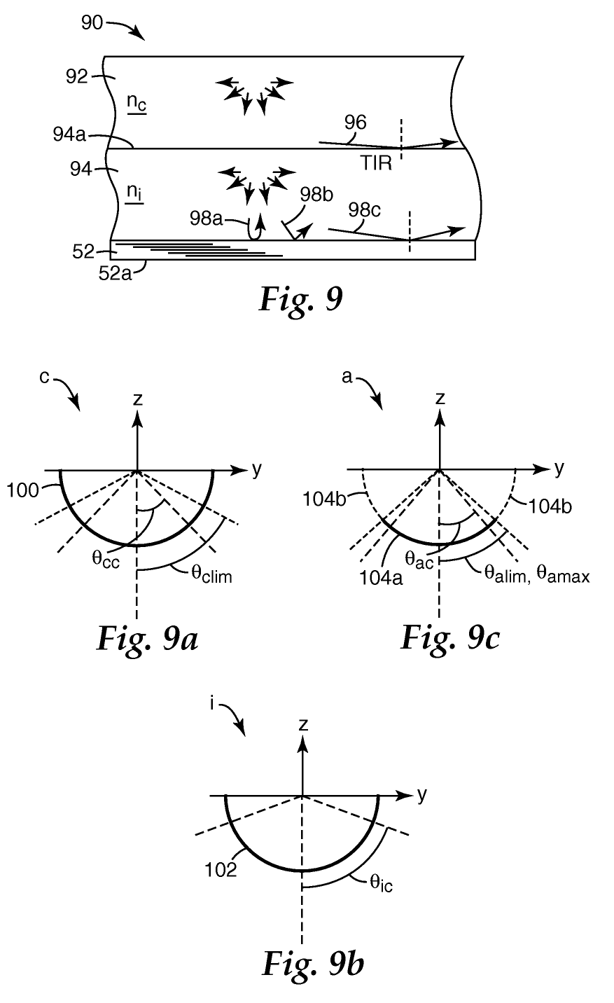

In order to provide a mirror system that can reflect light at extreme propagation angles without suffering from a loss of light at localized disturbances on an outer surface of the stack or at another outer surface of the mirror system, FIGS. 9-11 introduce an optically thick layer 94 composed of an optical material “i” having an intermediate refractive index nᵢ between that of air and the smallest refractive index of the microlayers in the stack, nₘᵢₙ. Exemplary low index materials, depending on the selection of materials in the thin film stack, include inorganic materials such as magnesium fluoride, calcium fluoride, silica, sol gels, and organic film-forming materials such as fluoropolymers and silicones. Aerogel materials are particularly suitable, as they can achieve extremely low effective refractive indices of about 1.2 or less, or even about 1.1 or less. Aerogels are made by high temperature and pressure critical point drying of a gel composed of colloidal silica structural units filled with solvents. The resulting material is an underdense, microporous media. Depending on the refractive indices of the microlayers in the multilayer stack, higher refractive index materials may in some cases be used for the optically thick layer, e.g., refractive indices of about 1.5 or less, 1.4 or less, or 1.3 or less. The optically thick layer is preferably at least about 1 micrometer thick, or at least about 2 micrometers thick, to avoid the phenomenon of frustrated total internal reflection.

In FIG. 9, a mirror system 90 includes thin film stack 52 described above, together with a first layer 92 of optical material “c” and optically thick layer 94 of optical material “i”. First layer 92 can be any one of elements 50, 60, 70, or 80, or combinations thereof It can be optically thick, optically thin, microscopic, macroscopic, organic (e.g., polymeric) or inorganic. Using any of the mechanisms described above, light propagates at supercritical propagation angles in layer 92, and in exemplary embodiments over all propagation angles. FIG. 9a shows an angular plot of the light propagating in layer 92, where full semicircular arc 100 represents light traveling at all angles of incidence θ_{c} in material c. FIG. 9a also shows the critical angle θ_{cc} for material c, as well as limiting angle θ_{clim}. Light propagating at the limiting angle θ_{clim} in material c refracts at grazing incidence into the lower refractive index material “i” of layer 94. Thus, light propagating in layer 92 at angles greater than θ_{clim} is totally internally reflected at an embedded surface 94a at which layer 92 contacts layer 94. This light is depicted in FIG. 9 by light ray 96. The other light propagating in layer 92 refracts into layer 94 and propagates therein over a full range of angles, depicted by semicircular arc 102 of FIG. 9b. Note that the light propagating in layer 94 includes light at angles greater than the critical angle in medium “i”, θ_{ic}.

Preferably, the refractive index nᵢ of layer 94 is selected as a function of the stack 52 design, such that light propagating at grazing incidence θᵢ=90° in medium “i” refracts into medium “a” of the stack at an angle θₐ≈θₐₘₐₓ. This condition ensures that light propagating at supercritical angles and even at extreme angles in medium “i” refracts into a layer of material “a” at an angle that can be satisfactorily reflected (at the target average reflectivity or higher, and in the wavelength range of interest) by the stack. Similarly, any light that propagates in material “a” at an angle θₐ>θₐₘₐₓ and encountering an interface with material “i” will totally internally reflect at such interface.

With this choice of material “i”, all light in the wavelength range of interest impinging upon stack 52 from layer 94 is reflected by the stack, with substantially no light reaching the outer major surface 52a. FIG. 9c shows light propagating in the “a” material of the microlayers in the stack in arc 104a (0≦θₐ≦θₐₘₐₓ), with arcs 104b showing no light propagating at higher angles. FIG. 9 shows light 98a, 98b, 98c of progressively higher incidence angles being reflected by the stack 52. Some light from layer 92 is reflected by TIR at an embedded surface of layer 94, and the remainder of the light from layer 92 is reflected by stack 52, without allowing any light to reach the surface 52a. Thus, unlike the mirror systems of FIGS. 5-8, mirror system 90 of FIG. 9 is insensitive to any disturbance at the outer surface of the mirror system, i.e., surface 52a. Yet, mirror system 90 can reflect light at all angles with at least the target average reflectivity through a combination of the stack 52 and optically thick layer 94. Mirror system 90 thus provides a “non-leaky mirror” over the wavelength range of interest.

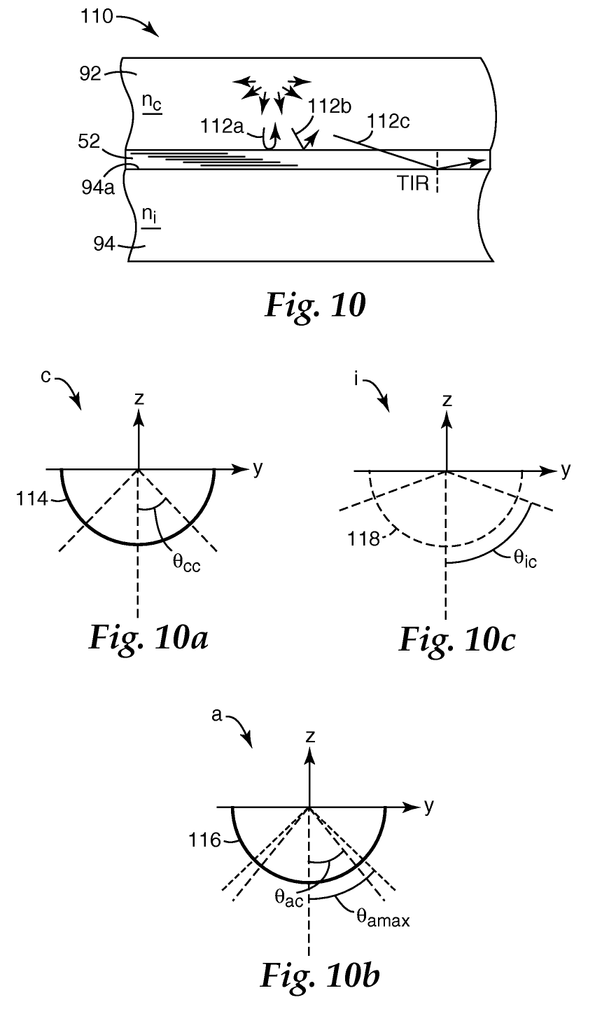

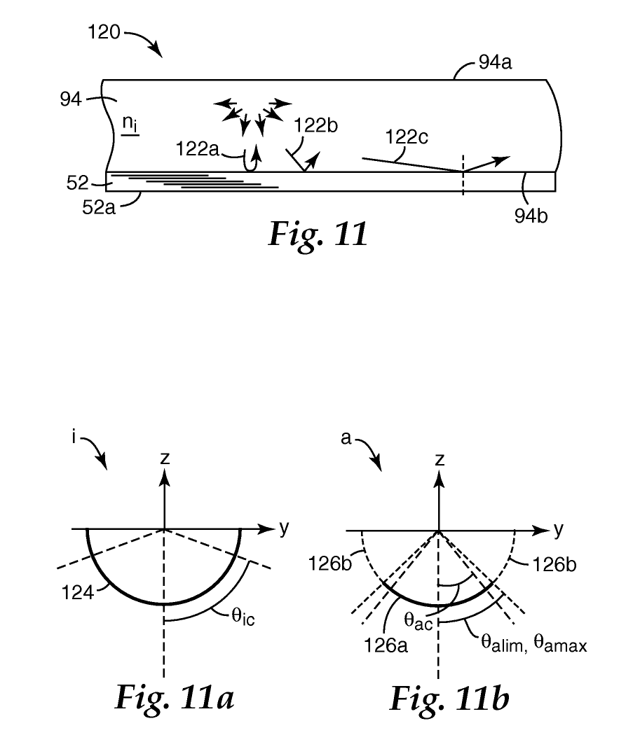

FIG. 10 shows a mirror system 110 similar to system 90, but where the placement of stack 52 is changed such that it is sandwiched between layers 92, 94. Here again, light propagates in layer 92 at supercritical propagation angles, and in exemplary embodiments over all propagation angles. FIG. 10a shows an angular plot of the light propagating in layer 92, where full semicircular arc 114 represents light traveling at all angles of incidence θ_{c} in material c, including supercritical angles greater than θ_{cc}. This light then encounters stack 52, including its microlayers of material “a” and “b”. Normally incident light 112a and some obliquely incident light 112b is reflected by the stack 112 conventionally, because it is refracted into optical material “a” at angles θₐ ranging from 0 to θₐₘₐₓ. However, the remaining light is refracted into material “a” at extreme propagation angles, and is not satisfactorily reflected by the stack. See FIG. 10b, where arc 116 depicts light propagating in material “a” at all incidence angles θₐ including angles greater than θₐₘₐₓ. Fortunately, layer 94 has a refractive index nᵢ that totally internally reflects extreme propagating light such as light 112c at embedded surface 94a. Such light travels back through stack 52 and into layer 92. All light incident on layer 94 from above is reflected at the surface 94a, and arc 118 in FIG. 10c shows that no light propagates in layer 94. Any disturbance 58 placed on the bottom major surface of layer 94 will not affect the reflectivity of the mirror system 110, because the layer 94 is thick enough to avoid any evanescent wave tunneling therethrough. Mirror system 110 thus also provides a “non-leaky mirror” over the wavelength range of interest.

FIG. 11 shows a mirror system 120 similar to system 90 of FIG. 9, but where layer 92 has been eliminated and where any of the structures described above to inject light at supercritical angles are incorporated into optically thick layer 94 of intermediate refractive index material “i”. Thus, light is injected by any of the disclosed techniques into layer 94 such that light propagates at all angles θᵢ in material “i”. This is shown by arc 124 in FIG. 11a. Due to the selection of material “i” and its refractive index nᵢ discussed above, all of this light is refracted into a microlayer of material “a” over a range of angles from 0≦θₐ≦θₐₘₐₓ, ensuring that the stack 52 satisfactorily reflects all of this light whether normally incident (122a) or obliquely incident at any angle (122b, 122c). Arc 126a of FIG. 11b shows light propagating at angles ranging from normal incidence to supercritical, but arcs 126b show that no light propagates beyond θₐ=θₐₘₐₓ.

As with mirror system 90, no light reaches the back outer surface 52a of mirror system 120, so any disturbance present or placed on such outer surface will not affect the reflectivity of the mirror system 120. At the same time, mirror system 120 reflects light over a wide range of incidence angles. Mirror system 120 provides a “non-leaky mirror” over the wavelength range of interest.

In the foregoing discussion we have described a variety of structures that can perform the specified function of injecting light at supercritical propagation angles in the optically thick layer of material “i” as well as in the microlayers of the thin film interference stack. One of these structures is fine light-scattering particles. When such scatterers are employed to provide diffusion (viz., light scattering) for a given application, then a variety of factors may be adjusted as needed to control the composite mirror characteristics. For example, the size, index of refraction, concentration, and distribution of the particles may be varied, as may the thickness of the layer (e.g., a skin layer, adhesive layer, or other layer) in which such particles are located. Another disclosed structure is a surface that has been shaped to define protrusions and/or depressions that scatter or deflect light by refraction at the surface. (Such surface may be part of a layer the can be laminated to the thin film stack, or it may be embossed directly into e.g. a skin layer or coating on the front side of the thin film stack.) A variety of factors can be used in this case also to control the composite mirror characteristics, such as the index of refraction, the shape, size, and surface coverage of the protrusion/depression elements, and other properties of the surface topology. Whether structured surface, scattering particle, or both, the details of construction of these structures can be tailored to produce desired amounts of light scattering or deflection. For example, the scattering can be strong enough to provide a substantially Lambertian distribution, or the scattering can be weaker. Also, the details of construction can be tailored to produce scattering at preferred angles or ranges of angles, depending on the intended application.

The foregoing description thus enables the fabrication of a variety of mirror systems having wide angular reflectivity. One such mirror system involves diffusely reflecting mirrors that are highly reflecting at all angles of incidence when immersed in a medium of any index of refraction. Such mirror systems are capable of uniformly reflecting light despite locally reduced reflectivity at a mirror backside region.

Exemplary embodiments will now be described in the following illustrative examples, in which all parts and percentages are by weight unless otherwise indicated.

### EXAMPLE 1

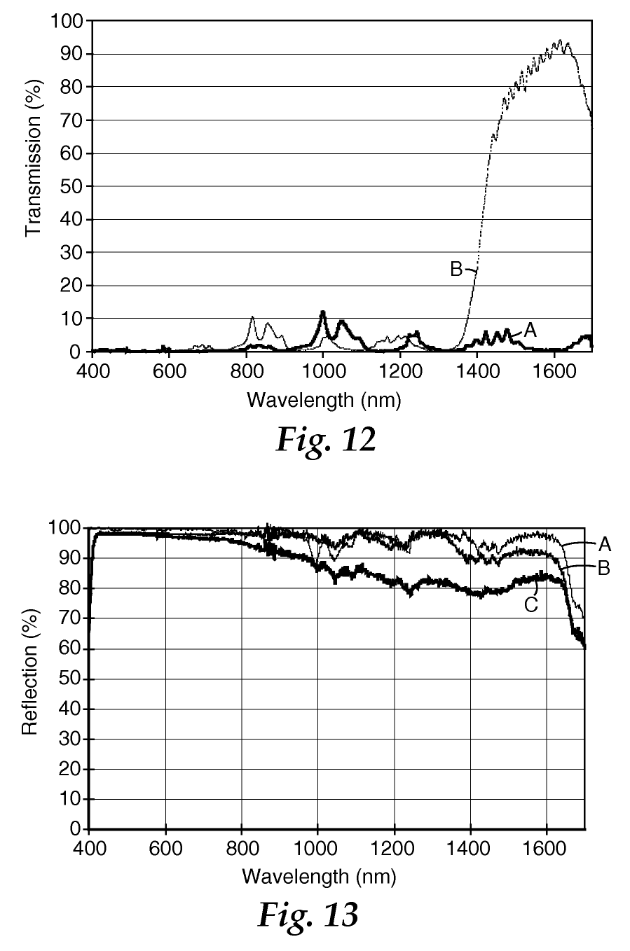

An extended band mirror film stack was made by using an optical adhesive to laminate together two multilayer mirrors made from oriented PEN and PMMA. The first mirror was made with 530 layers of PEN/PMMA formed using a multiplier and two packets of 265 layers each according to the methods described in U.S. Pat. No. 6,783,349 (Neavin et al.) to provide a visible and near-infrared mirror with a reflectance band, for normally incident unpolarized light, extending from about 400 nm to about 1000 nm. The second mirror was similarly made but contained only one packet of 265 layers of PEN/PMMA to provide an infrared mirror with a reflectance band from about 1000 nm to 1700 nm. Each mirror was biaxially stretched under suitable conditions to render the PEN material birefringent, with substantially equal in-plane refractive indices (measured at 633 nm) of about 1.75 and a z-axis refractive index of about 1.49, while the PMMA material remained substantially isotropic with a refractive index of about 1.49. The optical adhesive was 3M™ Optically Clear Laminating Adhesive 8141, a 1.0 mil (25 micron) thick acrylic pressure sensitive adhesive (refractive index approximately 1.4742 at 633 nm) available from 3M Company, St. Paul, Minn. The resulting wideband laminated mirror film stack had a reflectance band of about 400 nm to 1700 nm at normal incidence. For oblique incidence, the laminated stack maintains high reflectivity for light whose propagation angle θₐ measured in the PMMA material (designated here as material “a”) ranges from 0° to about 65°. As θₐ begins to exceed about 65°, the band edge for p-polarized light begins to move from near infrared wavelengths into visible wavelengths, causing reflectivity of the mirror system to drop rapidly. The rapid reflectivity drop starts at the long wavelength end of the visible spectrum (about 700 nm) and proceeds across the visible spectrum to shorter wavelengths as θₐ increases. Curve A in FIG. 12 is a plot of measured spectral transmission for the laminated mirror at normal incidence in air (for which θₐ=0), and Curve B is a plot of transmission for p-polarized light at 60° incidence in air (for which θₐ≈35.5°). Reflectivity values can be determined from the graph using the relationship R+T≈100%, where R is percent reflection and T is percent transmission at a given wavelength.

The wavelength range of interest for this laminated mirror device was the visible wavelength region, approximately 400-700 nm. The microlayer angular range of interest, over which adequate average reflectivity is provided, was about 0 to 65° for θₐ, with the upper limit of about 65° corresponding to θₐₘₐₓ.

A fluoropolymer diffusing layer was made in the following manner. A THV-500™ fluorpolymer resin (Dyneon LLC, St. Paul, Minn.) was extruded and cast as a 2 mil (about 0.05 mm) thick film using standard film making apparatus. The film contained about 2% by weight of titanium dioxide powder, of the type normally used in white paint. The powder was compounded into a separate masterbatch of THV to a weight percent of about 35%. Pellets of the masterbatch resin were then blended into the clear THV resin so that the final weight percent was about 2%. The refractive index of the THV fluoropolymer is about 1.35, which is lower than the refractive indices of both the PEN and PMMA microlayers in the mirror laminate and higher than the refractive index of air. Using the relationship nₐ*sinθₐₘₐₓ=nᵢ*sinθᵢₘₐₓ, this refractive index yields a propagation angle θᵢₘₐₓ in the THV fluoropolymer material, corresponding to θₐₘₐₓ in the PMMA material, of approximately 90°, depending on the exact value of θₐₘₐₓ, the exact refractive index value nᵢ of the THV fluoropolymer, and the exact refractive index value nₐ of the PMMA material. The parameter θᵢₘₐₓ is the maximum light propagation angle measured in medium “i” for which the thin film stack provides adequate reflectivity over the wavelength range of interest. It is related to θₐₘₐₓ by Snell's law. The significance of θᵢₘₐₓ≈90° is that this corresponds to light traveling in the THV material nearly parallel to the plane of the THV layer, and it means that light propagating at any and all possible oblique angles in the THV material will be adequately reflected by the mirror laminate.

The resulting diffuser film was laminated to the front side of the mirror laminate using the same optical adhesive used to laminate the two multilayer mirrors. The result was a mirror system having diffuse reflecting properties and a wide band (compound) interference stack. A local area of reduced reflectivity was created on the backside of the mirror system by applying black ink from a Sanford™ permanent marker to a limited area or zone on the exposed backside of the rear multilayer mirror.

Reflectivity was then measured. Unless otherwise noted, reflectivity was measured using a Lambda 19 spectrophotometer, an integrating sphere, and for reference purposes a NIST calibrated Lambertian white diffuse reflector. Light of each wavelength measured was incident normally on a limited portion of a given sample, and all such light reflected from the sample (over a hemisphere of solid angle, thus including both specularly and diffusely reflected light) was collected by the integrating sphere in order to calculate the percent reflectivity.

In FIG. 13, Curve A plots reflectivity measured in this way for the wideband mirror film stack by itself, i.e., the two laminated multilayer mirrors without the front diffusing layer and with no black ink applied to the backside. Curve B is a reflectivity plot for the entire mirror system, which includes both the wideband mirror and the fluoropolymer diffusing layer. Curve B was measured at a location on the front side of the mirror system whose corresponding backside had no black ink applied thereto. Curve C is similar to Curve B, but it is measured on a front side of the entire mirror system whose corresponding backside is completely coated with the black ink referred to above. As shown in FIG. 13, Curves A, B and C all demonstrate high reflectivity across the visible spectrum. Addition of the black backing layer to the mirror system of Curve B does not significantly reduce visible spectrum reflectivity.

When the wideband mirror film stack alone (FIG. 13, Curve A) is viewed from the frontside by a human observer, the mirror is shiny and provides specular reflection. When the mirror regions coated with only a fluoropolymer diffusing layer (FIG. 13, Curve B) and coated with both the fluoropolymer diffusing layer and black backing (FIG. 13, Curve C) are viewed from the frontside by a human observer, both mirror regions provide diffuse reflection. From the frontside the Curve B and Curve C mirror regions are indistinguishable, and it is necessary to turn the mirror system over in order to see where the black backing is located.

### COMPARATIVE EXAMPLE 1

A mirror system similar to that of Example 1 was constructed, but where the second multilayer mirror (whose normal incidence reflectance band extends from about 1000 to 1700 nm) was omitted. That is, only the first mirror, made with 530 layers of PEN/PMMA and having a normal incidence reflectance band extending from about 400 nm to about 1000 nm, was used. To the front side of this first multilayer mirror the diffusing film of Example 1 was applied, and to portions of the backside the black ink of Example 1 was applied. Reflectivity was measured in the same way.

Due to the reduced spectral width of the reflectance band of the first mirror alone compared to the mirror laminate of Example 1, the value of θₐₘₐₓ for this Comparative Example 1 is substantially less than the 65° value of Example 1, and the corresponding θᵢₘₐₓ for the diffusing film is substantially less than 90°. This means that a significant fraction of the oblique-propagating light in the diffusing film will not be adequately reflected by the multilayer mirror of this Comparative Example 1.

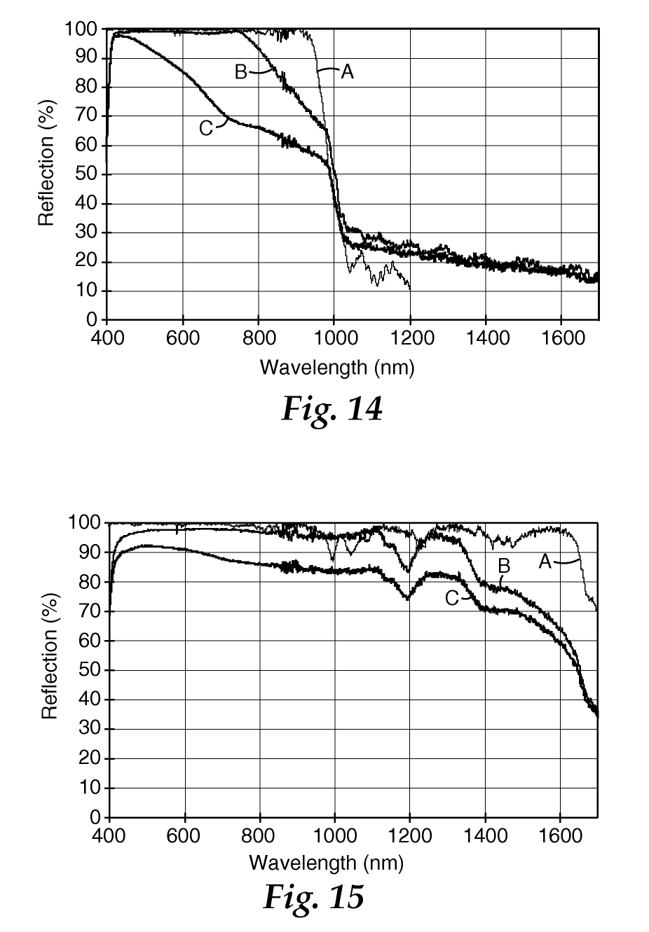

Curve A in FIG. 14 plots reflectivity for the first multilayer mirror by itself. Curve B plots reflectivity for a mirror system composed of the first multilayer mirror stack and the fluoropolymer diffusing layer applied to the front, but with no black ink applied to the back. Curve C is similar to Curve B but where the back of the mirror system includes the black ink layer. As shown in FIG. 14, addition of a black backing layer to the diffuse mirror system caused a significant decrease in visible spectrum reflectivity.

When viewed by a human observer, the Curve A mirror is shiny, provides specular reflection, and looks like the uncoated wideband mirror film stack of Example 1 (FIG. 13, Curve A). The Curve B and Curve C mirror regions provide diffuse reflection. When viewed from the frontside, the Curve C region is visibly darker than the Curve B region, and it is not necessary to turn the mirror over to tell the two regions apart.

### COMPARATIVE EXAMPLE 2

A mirror system similar to that of Example 1 was constructed, but where the THV-based diffusing film was replaced with a different diffusing film. In this Comparative Example 2, an alternative mirror system was made by applying a layer of white 3M™ Scotchcal™ 3635-70 Diffuser Film, commercially available from 3M Company, St. Paul, Minn., to the front side of the wideband mirror film stack of Example 1. This diffusing film has about 60% light transmission, and contains titanium dioxide particles dispersed in a polyvinyl chloride (isotropic refractive index of 1.54) matrix. The Scotchcal™ product also includes a clear pressure sensitive adhesive layer contacting the polyvinyl chloride diffusing layer. This adhesive layer was used to adhere the polyvinyl chloride diffusing film to the front side of the wideband mirror film stack. The thickness of the Scotchcal™ product, including both the adhesive layer and the diffusing layer, is about 3 mils (about 75 microns).

By increasing the refractive index of the diffusing layer from ˜1.35 to 1.54, the diffusing medium of this Comparative Example 2 is no longer strictly speaking “intermediate”, since its refractive index exceeds that of the PMMA microlayers in the multilayer reflector. Furthermore, the increase in refractive index lowers the limiting value θᵢₘₐₓ from the approximately 90° value of Example 1 to about 61°. This means, again, that a significant fraction of the oblique-propagating light in the diffusing film will not be adequately reflected by the multilayer mirror of this Comparative Example 2.

Curve A in FIG. 15 plots reflectivity for the mirror film stack by itself, which is the same as Curve A of FIG. 12. Curve B plots reflectivity for the alternative mirror system, including the Scothcal™ diffusing layer applied to the front side of the wideband mirror film stack, and with no black ink applied to the corresponding backside. Curve C is similar to Curve B, but where the black ink has been applied to the exposed backside corresponding to the front test area of the mirror system. As shown in FIG. 15, addition of the black backing layer to the Curve B mirror caused a significant decrease in visible spectrum reflectivity.

When viewed by a human observer, the Curve C region is visibly darker than the Curve B region (more so than was the case for the corresponding (Curve C) region of the Comparative Example 1 mirror system), and it is not necessary to turn the mirror over to tell the two regions apart.

### COMPARATIVE EXAMPLE 3

A mirror system similar to that of Comparative Example 2 was constructed, but where the second multilayer mirror (whose normal incidence reflectance band extends from about 1000 to 1700 nm) was omitted. That is, only the first mirror, made with 530 layers of PEN/PMMA and having a normal incidence reflectance band extending from about 400 nm to about 1000 nm, was used. The Scotchcal™ diffusing layer of Comparative Example 2 was applied to the front side of the first multilayer mirror using the clear pressure senstivie adhesive layer provided, and the black ink of Example 1 was applied to selected portions of the backside.

As we discussed in Comparative Example 1, by eliminating the second multilayer mirror we have reduced the spectral width of the thin film interference stack reflectance band, compared to the (laminated) interference stack of Example 1. Therefore, the value of θₐₘₐₓ for this Comparative Example 3 is substantially less than the 65° value of Example 1, reducing the value θᵢₘₐₓ to substantially less than 90°. A further difficulty here relative to Comparative Example 1 is that we have also increased the refractive index of the diffusing layer from ˜1.35 to 1.54, which decreases the value of θᵢₘₐₓ still further, allowing an even greater fraction of the oblique-propagating light in the diffusing film to be inadequately reflected by the multilayer mirror.

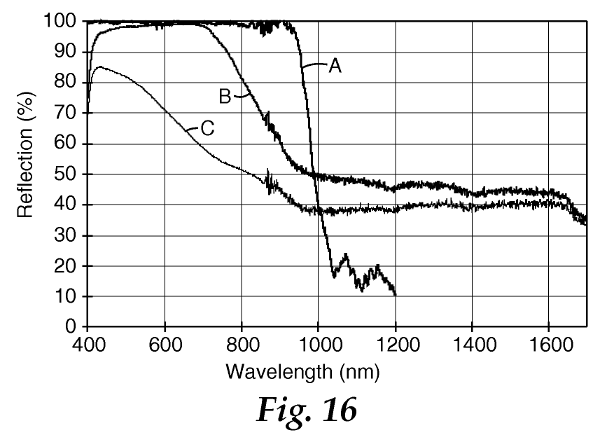

Curve A in FIG. 16 plots reflectivity for the first mirror film stack by itself, which is the same as Curve A in FIG. 14. Curve B plots reflectivity for the mirror system having the Scotchcal™ diffusing layer applied to the front of the first mirror film. Curve C is similar to Curve B but where the black ink is applied to the corresponding backside of the mirror system. As shown in FIG. 16, addition of a black backing layer to the Curve B mirror caused a significant decrease in visible spectrum reflectivity.

When viewed by a human observer, the Curve C region is visibly darker than the Curve B region (more so than was the case for the corresponding regions of the Comparative Example 1 and Comparative Example 2 mirrors), and it is not necessary to turn the mirror over to tell the two regions apart.

At least some embodiments of the disclosed mirror systems can provide the following combination of features: (1) high front-side reflectivity, including reflectivity for highly oblique light corresponding to supercritical propagation angles in the microlayers of the interference reflector, even in cases where (2) some or all of the backside of the mirror system is in contact with an absorbing material or other medium producing reduced reflectivity at the backside. These features can be advantageous in applications that call for attachment of the mirror system at the backside thereof to other components, and very high and uniform front-side reflectivity. For example, any of the diffusely reflective mirror systems described above can be secured to a wall or other supporting structure entirely by attachment to the backside of the mirror system, without having to use any attachment mechanism that would obstruct the front reflective surface of the mirror system. Furthermore, this can be accomplished without degrading the front-side reflectivity of the mirror system, even at areas directly opposed to attachment areas or points on the backside.

One application or end-use that may benefit from such design capability is backlight cavities for signs or displays, including but not limited to liquid crystal display (LCD) devices. The structural walls, including for example a large back surface and smaller side surfaces, of a backlight can be fabricated with materials having good structural properties but poor optical properties, such as injection-molded plastic or bent sheet metal. Then, a diffusely reflective mirror system as described herein, having excellent optical properties at least from the front side but which may have poor structural properties (e.g. poor rigidity), can be secured to the structural components exclusively by attachment to the backside of the mirror system, with little or no obstruction of the front side and little or no degradation of front-side reflectivity associated with the attachment points, such that reflectivity of the backlight cavity is maximized.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

Various modifications and alterations of this invention will be apparent to those skilled in the art without departing from this invention, and it should be understood that this invention is not limited to the illustrative embodiments set forth herein. All U.S. patents, patent application publications, and other patent and non-patent documents referred to herein are incorporated by reference in their entireties, except to the extent any subject matter therein is inconsistent with the foregoing disclosure.

What is claimed is:

1 An optical system, comprising:
a light source; and
a light guide, comprising;
a plurality of microlayers having refractive indices and thicknesses selected to substantially reflect light over a wavelength range of interest and over an angular range of interest; and
an optically thick layer optically coupled to the plurality of microlayers along a first major surface of the optically thick layer and having a side surface facing the light source for receiving light from the light source.

2. The optical system of claim 1, wherein the plurality of microlayers includes at least tens of microlayers.

3. The optical system of claim 1, wherein the plurality of microlayers includes at least hundreds of microlayers.

4. The optical system of claim 1, wherein the optically thick layer has a refractive index no less than the refractive indices of the microlayers.

5. The optical system of claim 1, wherein the wavelength range of interest is from 400 nm to 700 nm.

6. The optical system of claim 1, wherein the optically thick layer has an optical thickness that is on the order of an average wavelength in the wavelength range of interest.

7. The optical system of claim 1, wherein the optically thick layer has an optical thickness that is at least 10 times an average wavelength in the wavelength range of interest.

8. The optical system of claim 1 further comprising a liquid crystal panel for receiving light extracted from the optically thick layer along a second major surface opposing the first major surface.

9. The optical system of claim 8, wherein the second major surface comprises extraction features.

10. The optical system of claim 1, wherein the light guide is made by a co-extrusion process.

11. An optical construction, comprising:
a plurality of microlayers; and
a light guide optically coupled to and coextruded with the plurality of microlayers and comprising light extraction features on a major surface of the light guide for extracting light that is injected into the light guide from a side surface of the light guide.

12. The optical construction of claim 11, wherein each micro layer in the plurality of microlayers has an optical thickness that is a fraction of a wavelength in a wavelength range of interest.

13. The optical construction of claim 12, wherein the light guide has an optical thickness that is on the order of an average wavelength in the wavelength range of interest.
